(19) United States
(12) Patent Application Publication
(10) Pub. No.: US 2013/0000203 A1
(43) Pub. Date: Jan. 3, 2013

(54) DOOR ASSEMBLIES

(75) Inventor: Thomas William Platt, Walsall (GB)

(73) Assignee: COOKE BROTHERS LIMITED, Walsall (GB)

(21) Appl. No.: 13/583,366

(22) PCT Filed: Mar. 8, 2011
(86) PCT No.: PCT/GB2011/000333

§ 371 Date: Sep. 10, 2012

(30) Foreign Application Priority Data
Mar. 8, 2010 (GB) 1003816.4

(51) Int. Cl. E05D 15/54; E05D 5/04; E05D 3/02; E05B 65/06

(52) U.S. Cl. 49/246; 16/387

(57) ABSTRACT

FIG. (2) shows an anti-barricade door assembly (1) having a door (2) hinged to a door jamb (3) about a first, vertical, hinge axis H1. The door (2) consists of a generally planar, wooden laminated construction, main or central part (2a) bounded by an outer or peripheral, metal (steel) frame part (2b) that extends only around three edges (upper and opposed side edges 2c, 2d, 2e) of main door part (2a) but, importantly, not around the bottom edge (2f), of the main door part (2a). The main or central door part (2a) is pivotably mounted on the outer or peripheral frame part (2b) about hinge axis H2, said door part (2a) being pivotable inwardly, in normal use, about axis H2 to allow access to the interior e.g. of a prison cell.

This invention relates to improvements in or relating to door assemblies and is more particularly but not exclusively concerned with anti-barricade door assemblies e.g. for use in a prison, hospital or other institutionalised or selective access-controlled environment.

Anti-barricade door assemblies are known in which a door of the assembly may be pivoted inwardly relative to a door frame/jamb about a first hinge axis in normal use, in order to gain entry e.g. into a prison cell, said door being pivotable outwardly about a second hinge axis relative to the door frame/jamb e.g. under emergency conditions where the door may have been barricaded (or possibly inadvertently blocked) from the inside to prevent the door from being opened inwardly about the first hinge axis.

Such an anti-barricade door assembly is shown e.g. in British Patent Specification No. GB2450676A, which utilises a special hinge having an intermediate releasably lockable leaf. The arrangement shown in GB 2450676A tends to be disadvantageous in some respects e.g. the hinge employed is relatively expensive to manufacture and may not be engineered to be sufficiently strong or rigid in some instances, to take the weight of the door in an emergency situation when the intermediate leaf is unlocked, possibly resulting in distorted (not necessarily permanent distortion) bending of the hinge, fouling operation of the door assembly.

More particularly, when released any free movement within the hinge owing to either wear or initial excess movement between the hinge pivot pins and hinge leaves may create further distortion and twisting of the mechanism such that there is potential for the door to either foul in operation or to not be returnable to its original position seemingly without considerable difficulty.

Once again the design of hinge and fitting in the door assembly may unduly restrict or impose unnecessary limitations on the width of accessible door frame opening that can be achieved relative to door width i.e. the hinge tends to bulk out or take up the available opening width resulting in a narrower access opening (the opening width being measured from the inner door face—when opened at 90 degrees to the door frame—to the opposing door jamb) available than might otherwise be the case, more particularly when emergency access is required. The arrangement shown in GB2450676A may have other disadvantages; in particular the manner and number of operations required to unlock or release the intermediate leaf may be unnecessarily onerous or time consuming in a situation where quick emergency access is required.

Other double swing (inward and outward door swinging) door assemblies are known generally in a high use scenario e.g. as fire doors, but it is believed that they tend to be disadvantageous for various reasons; e.g. U.S. Pat. No. 6,170,210 shows a geared two way hinge that tends to be bulky and expensive.

It is believed that other known anti-barricade or double swing door assemblies tend to have other disadvantages; a special hinge construction may need to be utilised possibly increasing the cost and complexity of the door assembly, and the hinge construction in any event may be of insufficient strength or too bulky. Additionally, the hinge or edges of the door may be too easily accessible e.g. to an inmate in a prison or other institution where the door assembly is to be utilised in such a restricted access scenario.

Other door assemblies may have a door comprising an outer frame part and main part hingedly mounted to the frame part. The main door part is bounded on all four edges (two side edges and top and bottom edges) and can be pivoted in an emergency in an opposite direction (inwards) to the normal use (outwards) swinging of the door. The normal use of the door (comprising the outer frame part and inner main door part) is to be swung outwardly to allow exit e.g. from a building to which the door assembly is attached. In an emergency, the main door part can be pivoted inwardly relative to the outer frame part to allow a quicker escape from the building. It tends to be disadvantageous in such a scenario that the outer frame part has a lower, horizontal portion or member bounding the bottom edge of the main door part; when the main door part is opened relative to the outer frame for emergency access the lower horizontal portion/member of the outer frame part has to be stepped over which could prove to be an obstacle since a person exiting the building could trip over said lower horizontal portion/member resulting in possible injury.

It is also possible that the door assembly may be provided for converse use i.e. with the inner main door part being for normal use and the outer frame part and inner main door part being opened together in emergency use. In such situation, during normal access, the lower horizontal portion/member of the outer frame part would have to be stepped over thereby e.g. restricting access to a building/room.

In any event, often the hinge design in such door assemblies is required to be of reduced or anti-ligature construction, more particularly in a prison or institutionalised environment, to alleviate the possibly of an inmate, detainee or other person causing deliberate injury to himself by hanging a ligature therefrom, and adapting the hinge design of some double swing door assemblies to such an end may not be easy or practicable.

Additionally, such double swing door assemblies may utilise a continuous strip hinge extending from the top to the bottom of the door but in addition to the hinge possibly being too bulky in some situations when employed on the door it may still be of insufficient strength or rigidity and/or unnecessarily complex or expensive.

It is an object of the present invention to alleviate one or more of the disadvantages associated with known anti-barricade or double swing door assemblies or hinges for such assemblies or to provide an (anti-barricade) door assembly or door hinge improved in at least some respect.

According to one aspect of the present invention there is provided a door assembly comprising a door having a main part and an outer frame part, said outer frame part being pivotably mounted or mountable on a door jamb, in use, about a first hinge axis, and the main door part being pivotably mounted on the outer frame part about a second hinge axis spaced from the first hinge axis, the arrangement being such that, in normal use, the main door part is pivotable about the second hinge axis relative to the outer frame to open inwardly, e.g. into a prison cell or inmate's room and, when the main door part is prevented from being opened inwardly by e.g. a barricade, access into e.g. the prison cell/room, can be gained by pivoting the main door part with the outer frame part, outwardly about the first hinge axis.

In particular, embodiments of the present invention may provide a greater strength, rigidity, ease of use, speed of use and/or fire resistance than other known designs.

Further according to the present invention there is provided a room or confined space or building having at least one door assembly as described in the immediately preceding paragraph.

Whilst, in most cases the normal use of the door assembly will involve inward pivoting of the main door part only relative to the outer frame part in order to, advantageously, save wear and tear, more particularly, on the outer frame part and related parts, it is possible that the normal use and emergency use configurations could be interchanged so that in normal use the main door part and frame are opened together inwardly and the main door part only is opened outwardly, in emergency use.

Therefore, according to another aspect of the present invention there is provided a door assembly comprising a door arranged or arrangeable to be opened inwardly in use, by pivoting about a first hinge axis, e.g., into a prison cell, or inmate's room, said door having a main part and an outer frame part pivotable together about said first hinge axis, in normal use, the arrangement being such that if the door is prevented from being opened inwardly by e.g. a barricade, access, e.g. into the prison cell/room, can be gained by pivoting the main part of said door outwardly relative to the frame part, about a second hinge axis, spaced from the first hinge axis.

Usually, the first and second hinge axes will be parallel and usually arranged generally vertically, in use, normally on the same side of the door assembly and normally on opposite (inward and outward) faces of the door assembly adjacent to the same side edge of the main door part.

The door may be arranged for right or left handed operation as required.

Preferably, said outer frame part is of metal construction and/or the outer frame part preferably extends around the upper and opposed side edges of the main door part but not around a bottom edge of the main door part (to avoid an obstacle being provided that could be tripped over, when walking through the door, in use).

Usually, the outer frame part will have opposed side members bridged by an upper cross member and, conveniently, said frame members may be of the same or similar cross section connected together (e.g. by welding or attachment of a fixing plate etc).

In one embodiment of the door assembly, each of the frame members is of an L-shaped cross section which may be hollow and which, advantageously, may form a receiving rebate or groove to snugly receive the main door part, in a closed position of the door, or when the main door part and outer frame are pivoted together, generally in emergency use. Receiving the main door part in the rebate/groove should restrict access to the edges of said main part e.g. by a prison inmate, where the door assembly is utilised in a prison environment.

Preferably, the first hinge axis is provided by a hinge strip having an elongate leaf (usually attached to a door jamb) with spaced plate portions being pressed or cut out of said leaf (and usually attached to an outer edge of the outer frame part adjacent to said door jamb), said plate portions thus constituting a second leaf of the hinge, since said plate portions can be pivoted together in unison with the door when attached thereto. Advantageously, in a closed position of said hinge strip, the first and second leaves interlock so that only the thickness of one hinge leaf lies in between the door and door jamb, said hinge strip thus being compact and saving the additional thickness of at least one hinge leaf from interfering with the available door access opening.

Said hinge strip is, preferably, provided with an integrally formed tubular or knuckle section (that may be of generally known configuration) that may or may not be recessed (at least partially) in the door jamb, in use, for safety—anti-ligature reasons—and preferably the section itself is reduced-ligature or anti-ligature in format. The knuckle section may have at least one separately formed anti-ligature end cap.

Advantageously, the second hinge axis may also be provided by a second hinge strip of similar format to the first mentioned hinge strip. Usually, the plate portions of the second hinge strip will be connected to an edge of the main door part with the elongate leaf being attached to the inside edge of the outer frame part. Alternatively, the elongate leaf could be connected to the edge of the main door part with the plate portions being connected to the inside edge of the outer frame part.

In some instances, it may be advantageous to use a number of aligned relatively short hinges to reduce the cost of providing full length hinge strips whilst still maintaining the narrower hinge design.

The door assembly could also have the door hinged to provide the first hinge axis and/or second hinge axis using conventional continuous hinges, butt hinges, or concealed hinges which may assist in reducing cost; although they are likely to be either more bulky or require a more bulky outer frame part and may have an effect in reducing the maximum door opening compared to the aforementioned other hinging arrangements.

In one embodiment of the door assembly, any convenient or conventional locking means (mechanical or electro-mechanical or electromagnetic) may be provided to lock the main door part to the outer frame part such that, when released, conventional access into the room or cell is provided for and, when locked, the main door part is secured to the outer frame part. Additionally, means may be provided to lock the outer frame part to a main door portal frame (lock edge door jamb), such that, when released, the main door part and outer frame part can be opened together in a reverse direction to standard use.

Where electronic locking is provided to lock/release the outer frame part from the door jamb (for pivoting with the main door part) it is advantageous that only one operation (e.g. introduction of a key fob/electronic trigger to a sensor) may be required. Where mechanical locking is provided for the outer frame to the door jamb it is envisaged that two operations (e.g. upper and lower operations) may be required for operation, which may be turnkey operations. Where affordable, or where a faster release mechanism is required, electro-mechanical or electro-magnetic locking systems, releasable remotely, could be used instead of mechanical locking systems.

Furthermore, in one embodiment of the present invention, a special hook bolt may be provided that can pass into the outer frame part section, around a bar/retaining member therein, and back out to a lock body located in the door jamb. This may provide a further, important feature of the present invention, to improve the securing of the outer frame part to the door jamb such that the outer frame part is held securely back to the door jamb.

The outer frame part may or may not be locked to the main door part when required.

Further according to the present invention there is provided a door hinge comprising an elongate leaf adjacent an integral tubular or knuckle section of the hinge, said leaf having plate portions cut or pressed out therefrom, leaving recesses in the elongate leaf and said plate portions forming a second hinge leaf in use, the arrangement being such that, in a closed position of the hinge, the plate portions can re-enter the associated recesses in the elongate leaf.

Usually, the plate portions will be similar in size and/or spaced at regular intervals.

Further according to the present invention there is provided a door assembly having any feature or combination of features as described herein or having one or more of the following features:

a) A main door part with an outer peripheral frame not extending around a bottom edge of said main door part, the main door part being selectively pivotable, in use, relative to the frame part.

b) A main door part with an outer, metal frame part, said main door part being selectively pivotable, in use, relative to the outer frame part.

c) An outer frame part provided on a main door part, said outer frame being provided with a rebate or groove to receive edges of the main door part.

d) At least one hinge strip being an elongate leaf with plate portions being cut or pressed out therefrom to form a second hinge leaf.

e) Mechanical locking means preferably being of a multiple e.g double operation, such as a turn key operation

f) Electronic locking means preferably being of a single operation

g) Separately formed anti-ligature or reduced ligature end caps

h) Mechanical locking means including a hook bolt and/or preferably having a key which may or may not be captivated when operating (e.g. turning) the lock.

i) Bottom frame member guide assemblies

j) Means for a door closer

k) A main door part which has two releasably lockable parts or leaves e.g. vertically divided into two equal halves or divided into a width ratio of e.g 2:1

l) Outer side frame part guide spacer means preferably being adjustable along the side frame part

m) A protective strike plate

Many advantageous features of the present invention will be apparent from the following description and drawings.

An embodiment of an anti-barricade door assembly in accordance with the present invention will now be described, by way of example only, with reference to the accompanying, simplified, diagrammatic drawings, in which:

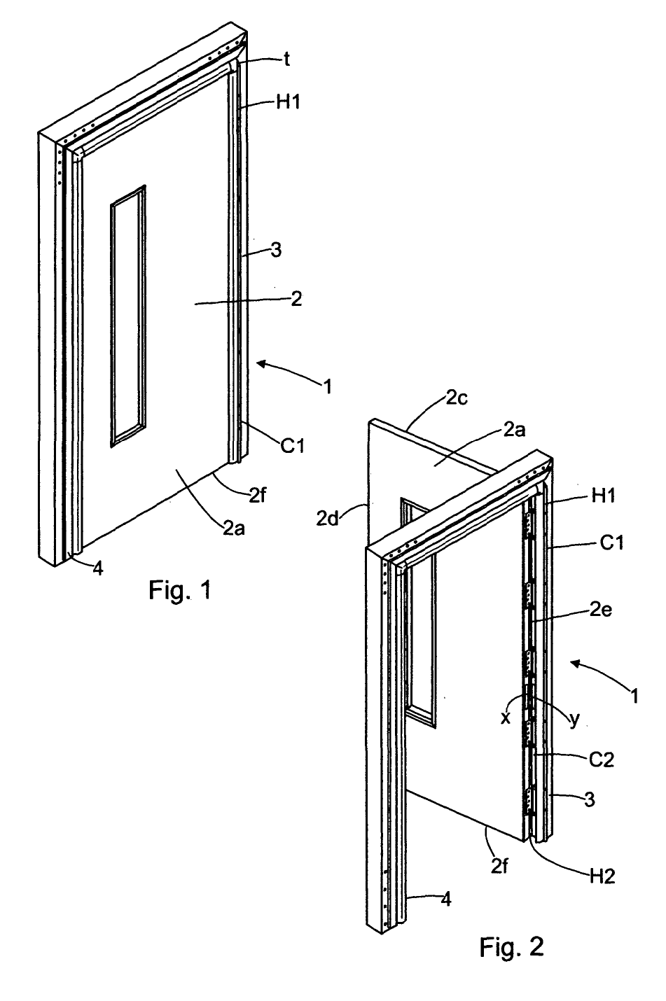

FIG. 1 shows a perspective view, in a closed position, of the anti-barricade door assembly viewed from the outside e.g. of a prison cell;

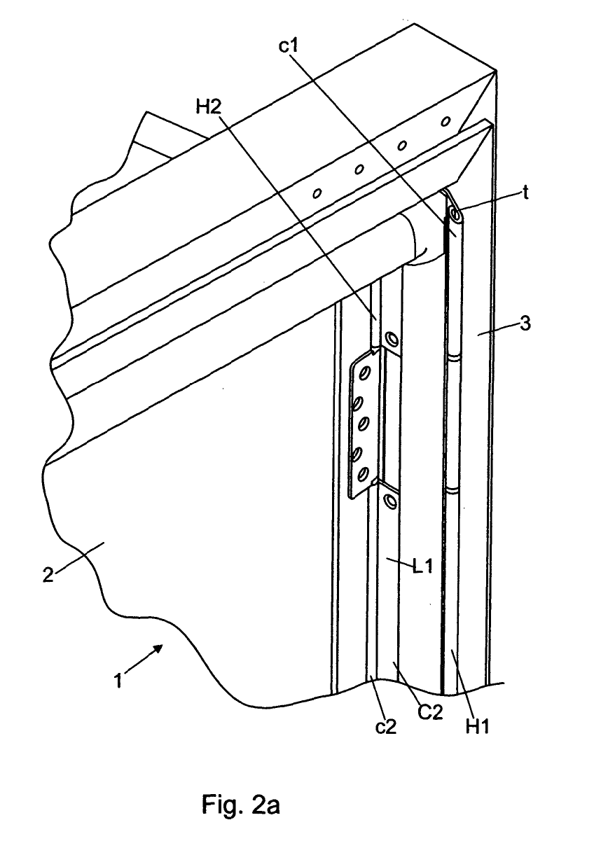

FIG. 2 shows a perspective view similar to FIG. 1, drawn to a different scale, with a main part of a door in a normal, inward, open position;

FIG. 2a shows an enlarged view of an upper right hand corner of the door assembly shown in FIG. 2;

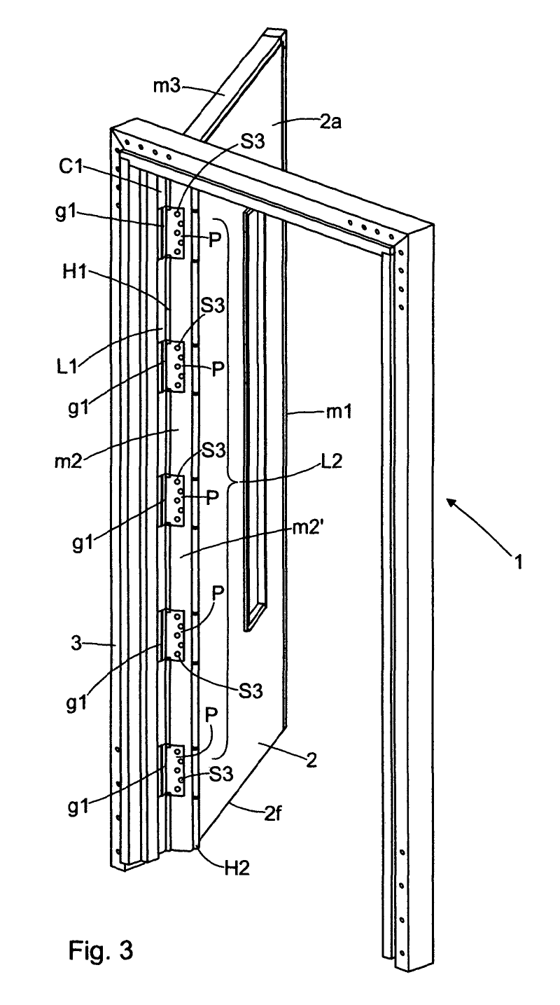

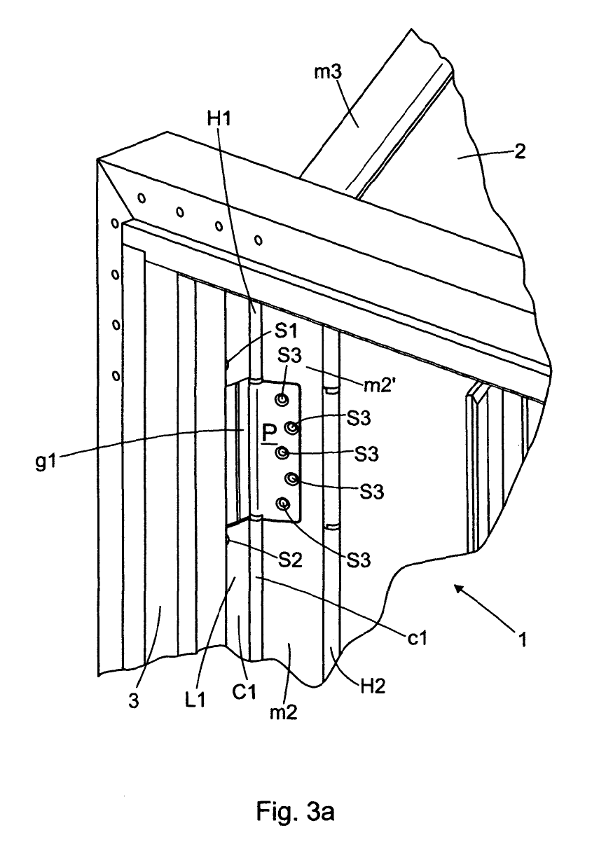

FIG. 3 shows a perspective view, drawn to a different scale, of the anti-barricade door assembly, in an, outward, emergency use, open position, viewed from the inside e.g. of a prison cell;

FIG. 3a shows an enlarged view of a corner of the door assembly shown in FIG. 3;

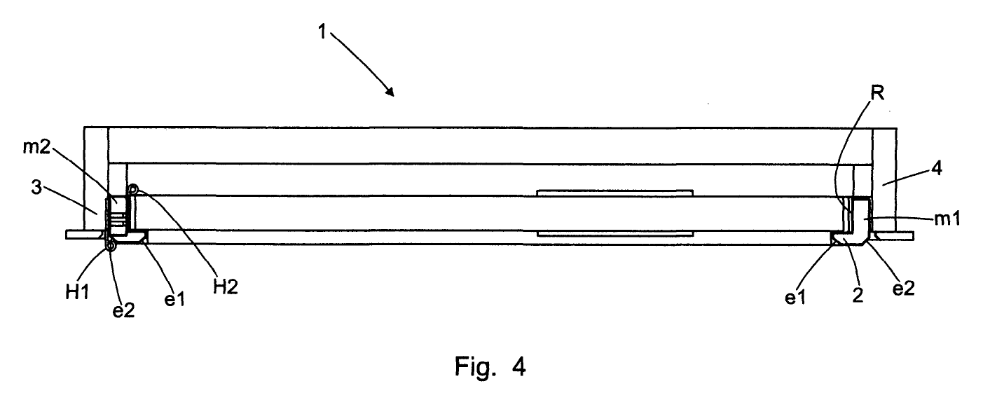

FIG. 4 shows an inverted plan view of the anti-barricade door assembly, in a closed position, corresponding to FIG. 1;

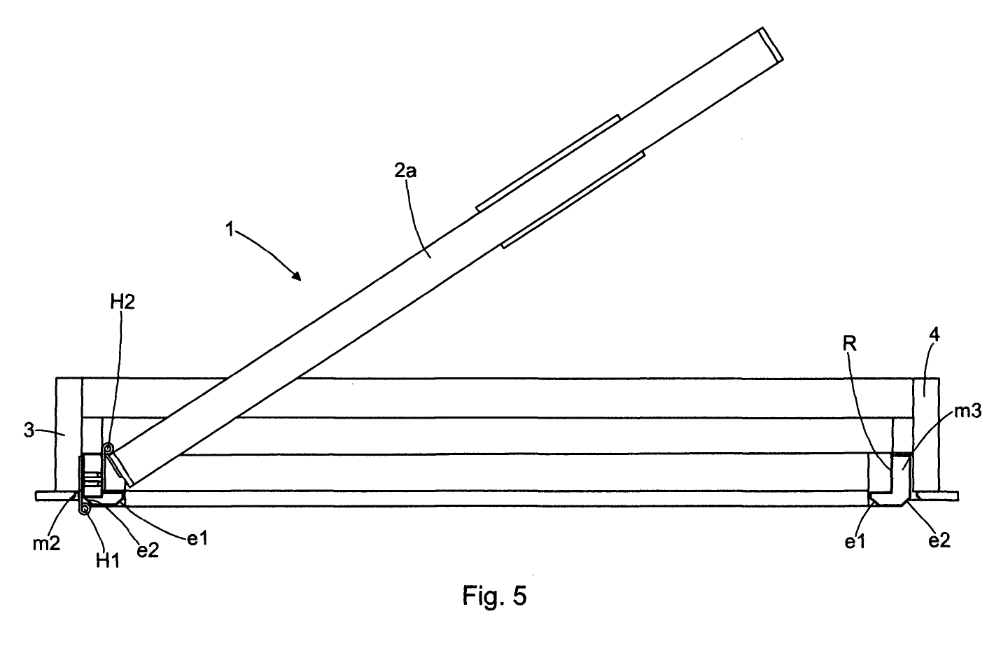

FIG. 5 shows an inverted plan view of the anti-barricade door assembly, with a main part of the door in a partially open, inward, normal use position, corresponding generally to FIG. 2, and

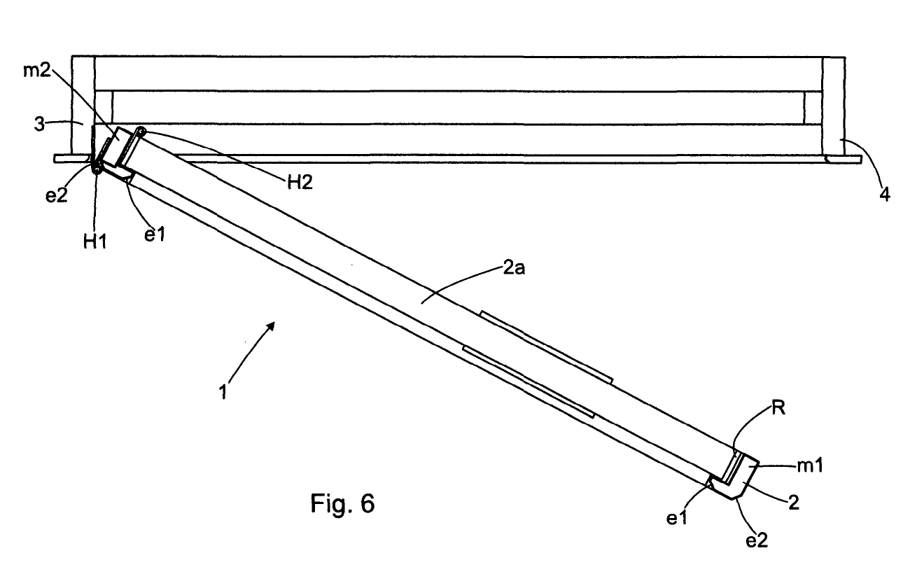

FIG. 6 shows an inverted plan view of the anti-barricade door assembly, in an outward, partially open, emergency use, position, corresponding generally to FIG. 3.

Referring to the FIGURES of the drawings, an anti-barricade door assembly 1 has a door 2 hinged to a door jamb 3 about a first, vertical, hinge axis H1. The door 2 consists of a generally planar, wooden laminated construction, main or central part 2a bounded by an outer or peripheral, metal (steel) frame part 2b that extends only around three edges (upper and opposed side edges 2c,2d,2e) of main door part 2a but, importantly, not around the bottom edge 2f, of the main door part 2a.

The main or central door part 2a is pivotably mounted on the outer or peripheral frame part 2b about hinge axis H2, said door part 2a being pivotable inwardly, in normal use, about axis H2 to allow access to the interior e.g. of a prison cell (not shown) ; see FIGS. 3, 3a, and FIG. 6, in particular.

Since the main door part 2a extends generally to floor level and the bottom edge 2f is not bounded by the frame part 2b, advantageously, the frame part 2b does not pose an obstacle (that could be tripped over) to entry into e.g. the prison cell.

The outer frame part 2b of door 2 has opposed vertical side members m1, m2 bridged by upper cross member m3.

Each of the members m1,m2,m3 is made up of a hollow, generally L-shaped cross section and they are connected together to form a receiving rebate or groove R to snugly receive or nestle the main part 2a of the door 2 therein, in a closed position of the door 2 (see FIG. 4) or to pivot with the frame part 2b outwardly about axis H1 (see FIG. 6) or to pivot relative thereto inwardly in normal use, about axis H2 (see FIG. 5). Advantageously, since the main part 2a is snugly received in rebate R, access to the edges 2c, 2d, 2e by e.g. a prison inmate is substantially restricted or prevented and also access to said edges is prevented/restricted from outside of the door assembly 1. The rebate R also helps the main part 2a to move smoothly with the outer frame part 2b when connected thereto. Additionally, the rebate R prevents gap formation between said edges 2c, 2d, 2e and the central part 2a when the door 2 is in a closed position, providing a more secure or protected appearance, preventing light from shining into the cell in between the main part 2a and outer frame part 2b.

Each member m1,m2,m3 is provided with an inner inclined outer edge surface e1 to provide a neat overall appearance and outer inclined chamfered edges e2 to accommodate the central tubular, or knuckle section c1 of the continuous hinge strip C1 (i.e. for left and right-handed door operation) connecting the outer frame part 2b to the door jamb 3 and providing the hinge axis H1. The continuous hinge strip C1 is of important design and is reduced or anti-ligature in format having a sloping top edge t (see FIG. 2a) to tubular section c1 being of similar format to sloping top edge (not shown) of central tubular section c2 of continuous hinge strip C2 connecting the main part 2a to the outer frame part 2b and providing the hinge axis H2.

In a modification (not shown) the central tubular section c1 made be accommodated in a purpose-made recess in the door jamb 4 as an additional anti-ligature precaution providing even less access to any support for a ligature to be hung from.

Advantageously, the hinge C1 is of continuous strip form having one leaf L1 extending the vertical height of the door 2 and which can be received in a purpose made recess of corresponding depth in the door jamb 3. Spaced countersunk holes (such as s1,s2 partly shown in FIG. 3a) are provided in leaf L1 to receive screws (not shown) to secure the hinge C1 to the inside of door jamb 3. A series of rectangular, hinged plate portions p are cut from leaf L1 at regular, spaced intervals, as shown in FIGS. 3, 3a, which together form a second, hinge leaf L2 (of course the plate portions p can be pivoted separately about hinge axis H1 prior to being secured to the outer vertical edge m2′ of vertical member m2 of the outer frame part 2b). Each plate portion p is provided with a plurality of countersunk holes s3 for receiving screws (not shown) to secure the plate portions p to vertical edge m2′ in a manner which should be readily envisaged from the FIGURES of the drawings.

It is believed that the continuous hinge strip C1 provided with a series of spaced plate portions cut from one hinge leaf to form a second (discontinuous) leaf is highly advantageous and cost effective in design which is also quite sufficiently strong for the purpose.

One of the main advantages to the hinge design is that the plate portions p rest or reside in the gaps g1 cut out the hinge leaf L1, when door 2 is in the closed position, adding to the strength of the arrangement and providing a neat compact hinge which does not reduce the available access opening of the door assembly in the same manner as if the hinge had two leaves arranged together side by side, when closed, instead of one within the other (i.e. resulting in only one hinge leaf depth rather than two) when closed as in the afore-described arrangement.

Also, advantageously, hinge C2 is of similar construction to hinge C2, with leaf L1 being attached to the inside of member m2 of the outer frame part and the plate portions p being attached to the edge 2e of the main door part 2a see FIG. 2.

A door closer (not shown) may be employed on the door assembly 1 (to automatically close the main door part 2a) from the position shown in FIG. 2 which may possibly be located in purpose-made recesses X,Y (see FIG. 2) in the door jamb 3 and door edge 2e respectively.

The door 2 may be provided with any convenient handle means (not shown) and the main door part 2a can be locked against inward pivoting about axis H2 by a locking mechanism (not shown—e.g. mechanical key operated locking mechanism). The main door part 2a may be locked (by said locking mechanism) to the outer frame part 2b (e.g. by edge 2d of the main door part 2a being locked to member ml of frame part 2b via a retractable latch means—not shown—in the main part 2a, engageable in a recess in member m1) so that the main door part 2a is locked against pivoting inwardly about axis H2, whilst member m1 of the outer frame part 2b is also, simultaneously, locked to adjacent door jamb 4 (opposed to door jamb 3).

In normal use, the main door part 2a is unlocked from member m1 of the outer frame part 2b (e.g. by manually unlocking a key operated locking mechanism), the door handle operated (e.g. turned) to retract the latch and the main door part 2a pivoted inwardly as required about axis H2 relative to member ml of the outer frame part 2b and adjacent door jamb 4.

In normal use, member m1 of the outer frame part 2b is releasably locked to the door jamb 4 by a second locking mechanism of any convenient form e.g. by an electronic and/or mechanical locking mechanism (not shown), to prevent pivoting of the outer frame part 2b (with main door part 2a) about axis H1.

Such an electronic locking mechanism may take the form of a sensor (not shown) conveniently mounted on the door jamb 4 and which is sensitive to a trigger device (such as a key fob—not shown) placed in close proximity thereto, to open and close the second locking mechanism being responsible for holding and releasing the member m1 to/from the door jamb 4.

Such mechanical locking mechanisms may take the form of vertically spaced upper and lower turn keys mounted on the front face of jamb 4 or member m1, each having latch means that can be rotated into and out of locking engagement with the jamb 4 and member m1, in a manner which should be readily envisaged.

Member m1 (and thus the outer frame part 2b) may be locked to the main part 2a, so that door 2 can pivot outwardly about axis H1, by any convenient means e.g. electro-magnetic latching operated simultaneously with the second locking means.

Advantageously, embodiments of the present invention may provide for the following:

a. The use of a door closer or a standard design, but not necessarily allowing for all conventional designs, such that the main door part can be operated with a self closing device.

b. The incorporation of fire resisting components such that the system (door assembly) can be certified to the relevant fire rating

c. The ability for the system to be designed into new build, or to be incorporated into renovation/replacement door set installations

d. The ability for the door set to be fitted with conventional, but not necessarily all types, of door acoustic and smoke seals

e. The system to include for centralised remote locking systems for both main door part and the outer frame part locking and release mechanisms.

f. The ability to work with conventional door blanks, together with the said blanks' ability to be conventionally clad.

g. The ability for the system to blend with the standard design of door sets having door architrave styles similar to conventional installations

h. The ability for the system to take substantial door weights and to exhibit substantial levels of overall strength and resistance to abuse.

i. The ability of the system to withstand high levels of operational cycles when used conventionally.

j. The ability of the system subject to third party testing to comply with all relevant certification standards for conventional doors in such locations.

k. The ability for electrics/electronics to be fed to the door blank in order to operate electric/electronic features mounted on or within the main door part such as electronic locks or smart glass vision panels.

l. The ability for the system to be supplied in either a fully rigid frame or in knock down component form for factory or site assembly.

The Applicant has various improvements to the anti-barricade door assembly.

Accordingly, embodiments of improved/ changed features of the anti-barricade door assembly in accordance with the present invention will now be described, by way of example only, with reference to the further accompanying, simplified drawings, in which:

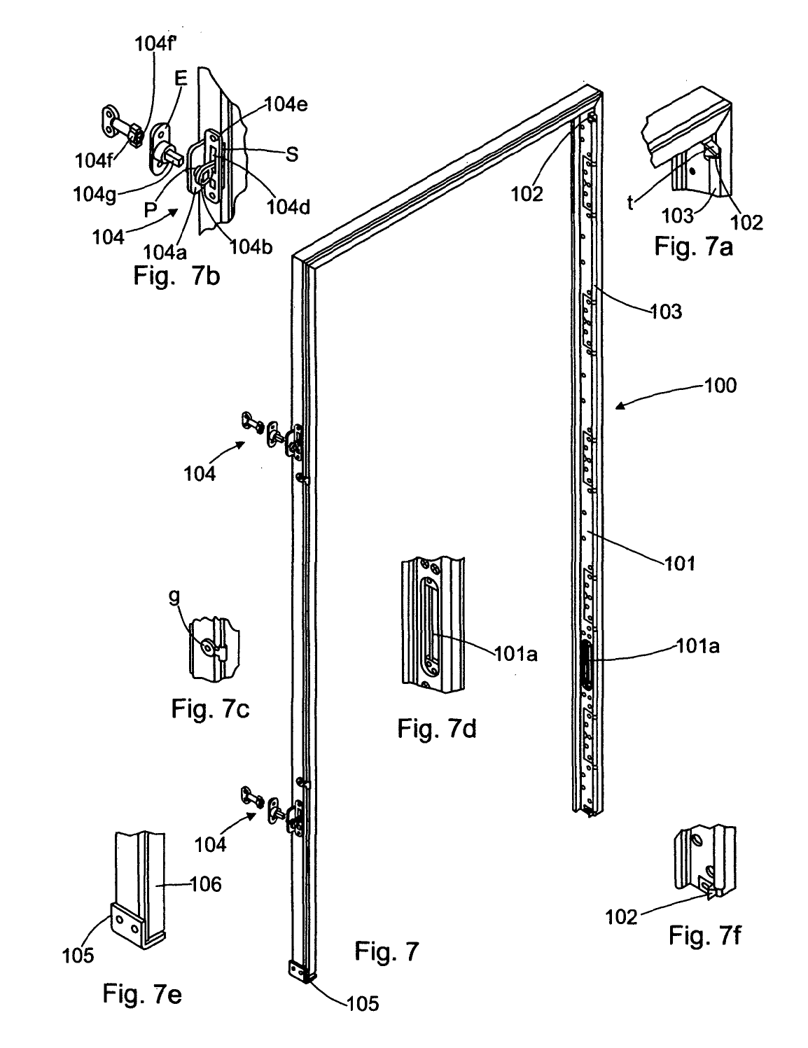

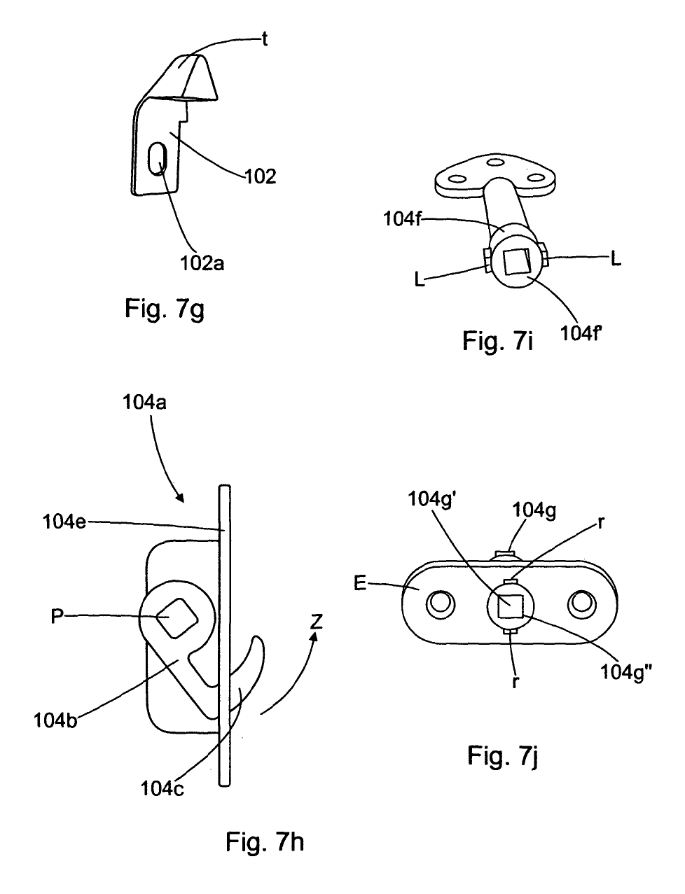

FIG. 7 shows a perspective view of a peripheral frame part a modified embodiment of an anti-barricade door assembly of the present invention and FIGS. 7a, 7b, 7c, 7d, 7e, 7f, 7g, 7h, 7i, 7j show detailed features of the frame part;

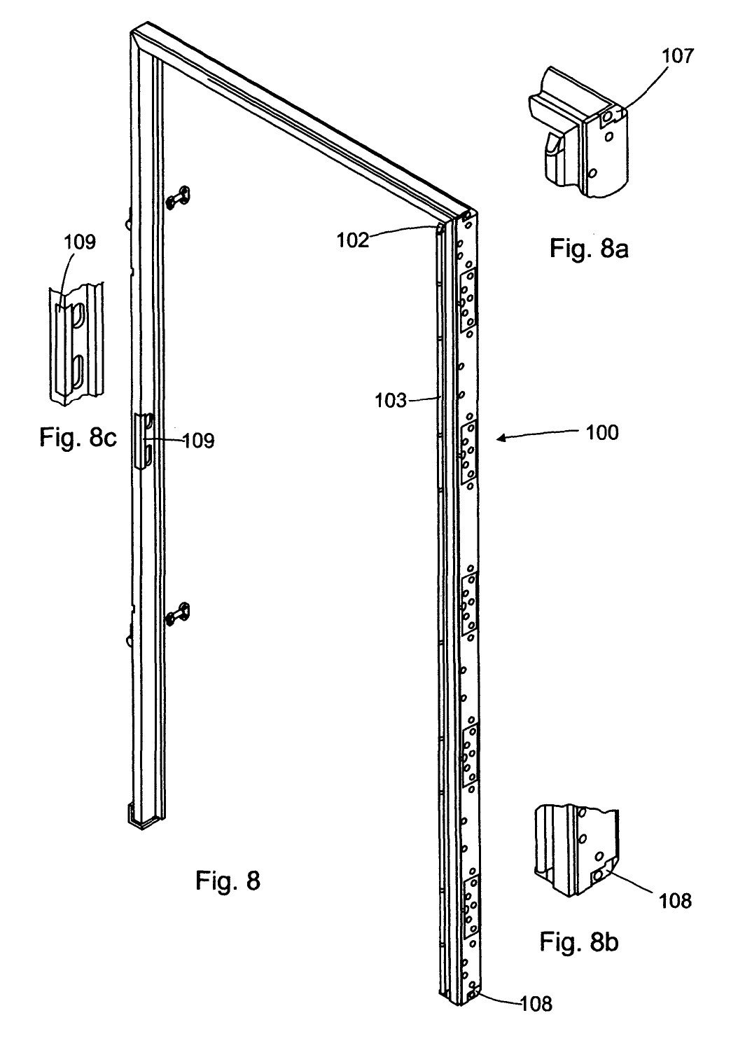

FIG. 8 shows a second, perspective view of the frame part shown in FIG. 7 and FIGS. 8a, 8b, 8c show more detailed features of the frame part, and

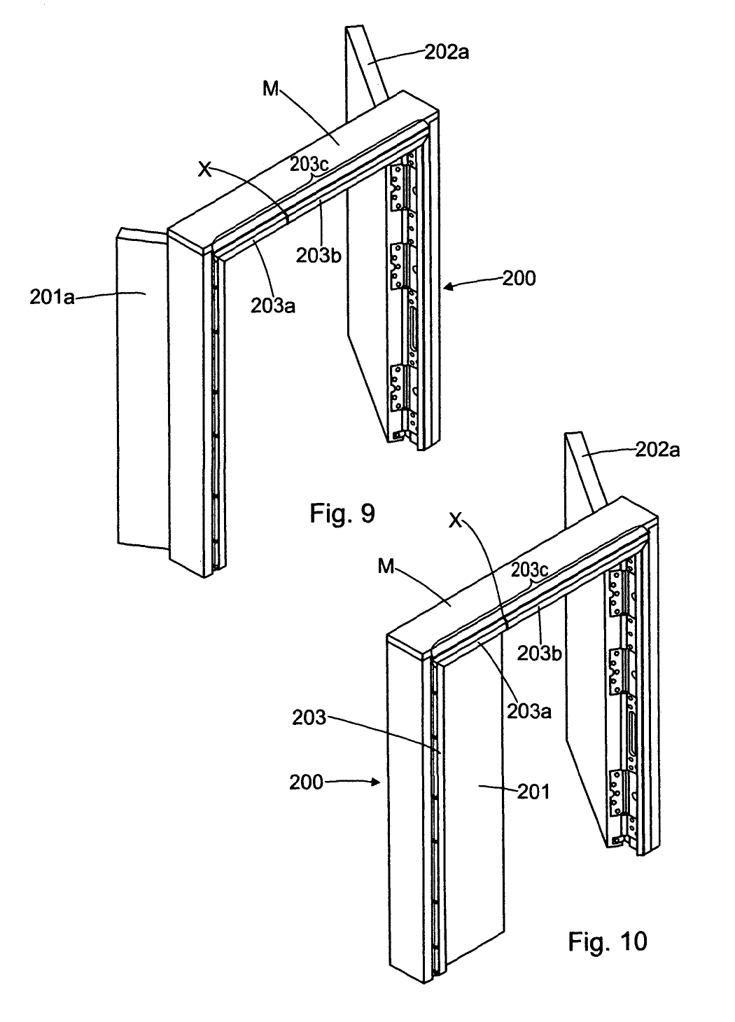

FIGS. 9 to 14 show various perspective views of a further embodiment of an anti-barricade door assembly in accordance with the present invention in which the door of the assembly is split into two vertical parts or leaves allowing separate use of the parts/leaves when required:

FIG. 9 shows the main or central door part leaf portions of the door opened inwardly;

FIG. 10 shows only the larger, main door leaf door portion opened inwardly with the smaller width leaf door portion closed;

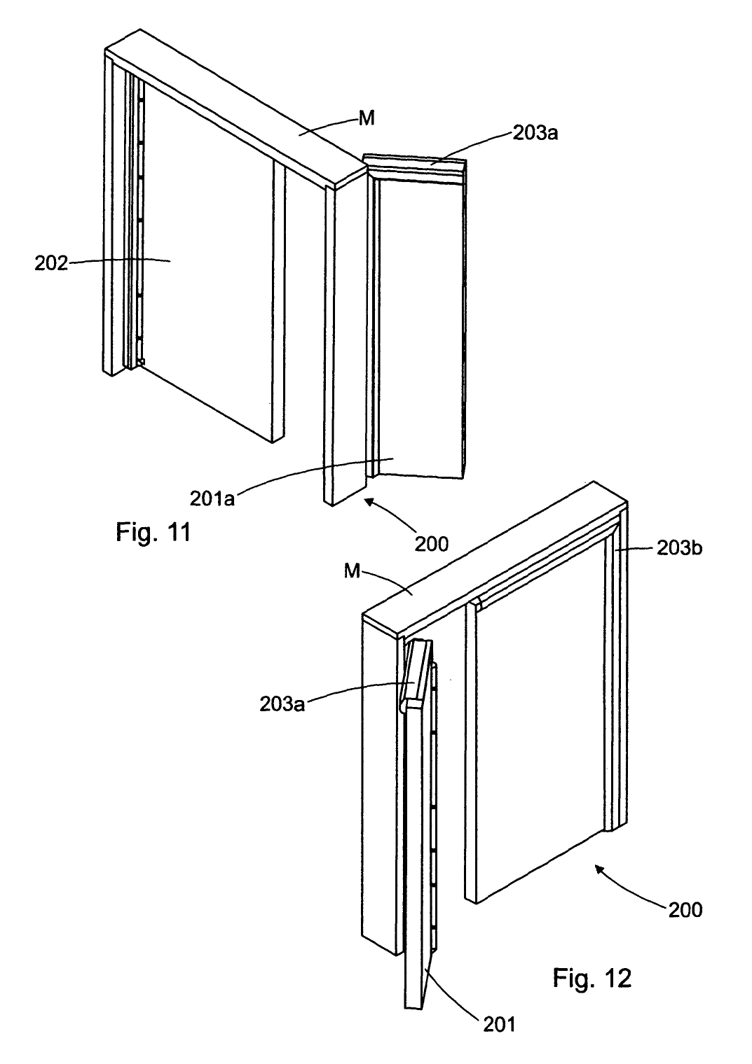

FIG. 11 shows an inside perspective of the larger, main door leaf door portion closed with the smaller width leaf door portion opened outwardly;

FIG. 12 shows a view similar to FIG. 11 but is an outside perspective view, and

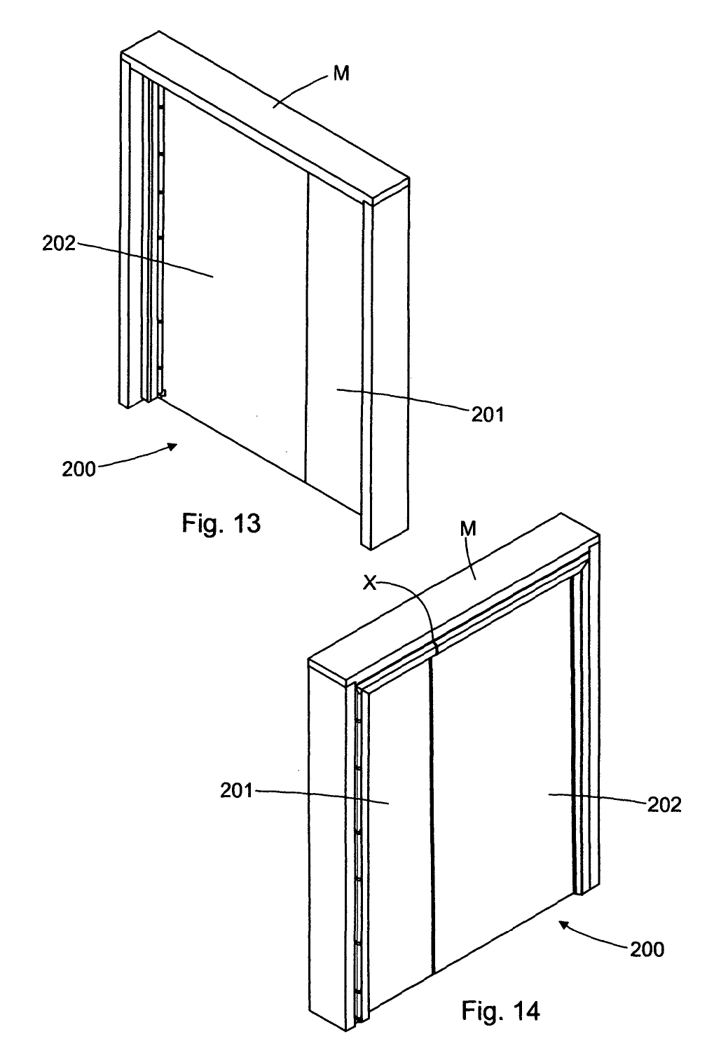

FIGS. 13 and 14 show inside and outside perspective views of both door leaves in a closed position.

Referring to FIGS. 7, 7a, 7b, 7c, 7d, 7e, 7f, 7g, 7h, 7i, 7j of the drawings, a frame part 100 may be provided for the anti-barricade door assembly 1 as shown in FIGS. 1 to 6.

The frame part 100 is of the same general form as frame part 4 shown in FIGS. 1 to 6 but has some additional, advantageous features.

Continuous hinge strip 101 is similar to hinge strip C1 but includes a separately formed anti-ligature (or reduced ligature) piece or end cap 102 fitted the top of the hinge knuckle 103. A perspective view of the end cap 102 is shown in FIG. 7g. The end cap 102 is retained to the hinge strip 101 by means of a fastener (screw)—not shown—that can be passed through receiving hole 102a to retain the end cap to the hinge strip 101. End cap 102 provides the anti-ligature sloping top edge t (see FIG. 2a).

As previously explained, in relation to FIGS. 1 to 6, a mechanical key operated mechanism may be provided for locking the main door part 2a against inward pivoting about axis H2 via a retractable latch means.

Also, as previously explained, such mechanical locking mechanisms may take the form of vertically spaced upper and lower turn keys, each having rotatable latch means. Such mechanisms are now shown in FIGS. 7 and 7b designated by reference numerals 104.

Each mechanical locking mechanism 104 consists of a cam lock 104a which, in use, is mounted on the door jamb 3 (shown in FIGS. 1 to 6) in a manner which should be evident. Cam lock 104a (see exploded FIG. 7b) has a rotatable hook bolt 104b rotatable from the partially closed position shown in FIG. 7h to the locked position shown in FIG. 7b. Rotation of hook bolt 104b in the direction of arrow Z moves the hook bolt to the locking position with hooked end 104c extending through rectangular aperture 104d in plate 104e of cam lock 104a and engaging strike plate S attached to frame part 100. The action of the hook bolt 104b pulls the frame part 100 firmly into the correct location.

Key 104f (see FIG. 7i) has an internal square section hollow tubular end 104f′ able to engage over the end 104′g of spring-loaded square section latch bar 104g (of anti-ligature escutcheon E—see FIG. 7j) to grip and turn the bar, in use, which bar engages and turns a central pivot p on which is mounted the hook bolt 104b, thus turning the hook bolt.

Key 104f is inserted into the escutcheon E so that diametrically opposed rectangular lugs L enter complementary receiving recesses r in the escutcheon E with accompanying simultaneous depression of axially slidable, spring-loaded ring piece 104g″ that surrounds end 104g′ of latch bar 104g. Thus end 104g′ of latch bar 104g seats snugly in the complementary square hollow tubular end 104f of the key 104f.

After key 104f is inserted into the escutcheon E, as aforementioned, and turned, lugs L engage behind the rear face of the escutcheon to retain or captivate the key 104f to the escutcheon, which turning action rotates the hook bolt 104b in a manner which should be self-explanatory.

Rotation of the key 104f in the reverse direction to the original angular position allows the lugs L to mate again with the recesses r and the key to be released from the escutcheon E.

In an alternative embodiment (not shown) The key 104f may be provided with an internal polygonal (e.g. hexagonal) rather than a square section being complementary to a similar polygonal section latch bar 104g.

In such an arrangement, it is envisaged that no lugs L or recesses r will be provided so that the key 104f is not retained to, or captivated in, the escutcheon E while turning the key 104f. This may be a preferable embodiment in certain instances, more particularly where quick release of the key from the locking mechanism is required.

Lines or other indication/alignment means may be provided e.g on the spring loaded ring piece 104g and the Estcheon E to show the locking and unlocking positions of the locking mechanism 104.

FIG. 7e shows an arrangement 105 being an optional bottom guide assembly for the bottom edge of frame limb 106 of frame part 100 and bottom edge of the hinge 103 is also provided with a separate anti-ligature end cap 102 (FIG. 7f).

Hinge strip 101 is also, advantageously, provided with an aperture 101a (see FIG. 7d) for a door closer (e.g. a Powermatic Perko door closer).

A spacer means in the form of an annular spacer g is also provided (see FIG. 7c) to maintain a 3 mm gap (in this instance) between the main or central door part 2a (see FIGS. 1 to 6) and frame part 100 fitted to door jamb 3. Advantageously, a plurality of such spacer means (e.g. three vertically adjustable spacer means) may be provided on each vertical side member of the frame part 100.

FIG. 8 shows an opposite perspective view of the frame part 100 with anti-ligature end caps 107, 108 fitted to the top and bottom (see FIGS. 8a, 8b) of frame part 100 as shown.

FIG. 8c shows a detail of an additional, protective strike plate 109 of right-angled format. The strike plate 109 fits on the frame part 100 and prevents rubbing on the frame part that might otherwise occur that could result in damage to the surface finish or coating provided on the frame part 100.

Additionally, and importantly, although not shown, the anti-barricade door assembly could be modified to provide a vertically split door arrangement i.e. the main door part 2a itself being split into two leaves selectively lockable to one another (preferably at the top and/or bottom). Said leaves may be of equal width or of width in the ratio of 1.5 to 1.

Also, the anti-barricade door assembly may be a refurbishment fit rather than an initial installation.

As previously stated, electronic locking means may be provided instead of mechanical locking. Such an arrangement may comprise a solenoid, (tapered) shot bolt.

It is preferred that the electronic locking utilises electro-magnets arranged to operate under face contact (i.e. sliding contact forces) to move the shot bolt, thus enabling greater contact force with electro-magnets of the electronic locking arrangement.

FIGS. 9 to 14 show views of a further embodiment of an anti-barricade door assembly 200 in which the door 201,202 is divided into two door leaves 201, 202 of different width (divided in the width ratio of 1:2)

Each door leaf 201,202 has a main or central door leaf portion 201a,202a which may be arranged to pivot with or without an outer peripheral portion 203a,203b of outer peripheral frame part 203, as should be evident from FIGS. 9 to 14 of the drawings.

Frame part 203 is divided into two portions 203a,203b with the upper cross member 203c of frame part 203 being split at X.

In the arrangement as shown, only the smaller width door leaf 201 is anti-barricade; the peripheral frame portion 203b is only there for aesthetics (it is simply fixed to the inside of the door jamb) and would not open outwardly with the main or central door leaf portion 202a. For this option a roller type door catch may be used. Upper and lower flush bolts (not shown) may be provided to fix the position of the door leaf 201 when not in use. The upper bolt may be fitted on the outside of the door assembly 200 and bolt into the frame part fixed frame portion 203b. The lower bolt, also fitted on the outside of the door assembly, may bolt into the floor acting as a second bolt for fixing the position of the anti-barricade door leaf 201. A hook lock (not shown) may be provided in the upper cross member M connected to the door jamb to secure the anti-barricade frame portion 203a or, alternatively, a second, upper flush bolt could be fitted to the door which bolt would pass through the frame part 203 into the cross member connected to the door jamb.

The door leaf 202 may be fitted with a Perkomatic door closer lockset and door handles as required.

It is to be understood that the scope of the present invention is not to be unduly limited by the particular choice of terminology and that a specific term may be replaced or supplemented by an equivalent or generic term. For example, the term ‘door’ could be replaced by ‘panel’; ‘door assembly’ may be replaced by ‘closure’; the terms ‘top’, ‘bottom’, and ‘horizontal’, ‘inside’ and ‘outside’ or ‘inward’ and ‘outward’ may be used to explain possible relative positions of various components of the door assembly, in use, and need not necessarily be limiting. Further it is to be understood that individual features, method or functions relating to the door assembly or parts thereof (e.g. hinges, anti-ligature features or locking features) might be individually patentably inventive. The singular may include the plural and vice versa. Additionally, any range mentioned herein for any parameter or variable shall be taken to include a disclosure of any derivable sub-range within that range or of any particular value of the variable or parameter arranged within, or at an end of, the range or sub-range.

1. A door assembly comprising a door having a main part and an outer frame part, said outer frame part being pivotably mounted or mountable on a door jamb, in use, about a first hinge axis, and the main door part being pivotably mounted on the outer frame part about a second hinge axis spaced from the first hinge axis, the arrangement being such that, in normal use, the main door part is pivotable about the second hinge axis relative to the outer frame to open inwardly, e.g. into a prison cell or inmate's room and, when the main door part is prevented from being opened inwardly by e.g. a barricade, access into e.g. the prison cell/room, can be gained by pivoting the main door part with the outer frame part, outwardly about the first hinge axis.

2. A door assembly comprising a door arranged or arrangeable to be opened inwardly in use, by pivoting about a first hinge axis, e.g., into a prison cell, or inmate's room, said door having a main part and an outer frame part pivotable together about said first hinge axis, in normal use, the arrangement being such that if the door is prevented from being opened inwardly by e.g. a barricade, access, e.g. into the prison cell/room, can be gained by pivoting the main part of said door outwardly relative to the frame part, about a second hinge axis, spaced from the first hinge axis.

3. The door assembly as claimed in claim 1 in which the first and second hinge axes are parallel and/or in which the first and second hinge axes are arranged generally vertically, in use and/or in which the first and second hinge axes are on the same side of the door assembly, preferably on opposite (inward and outward) faces of the door assembly adjacent to the same side edge of the main door part and/or in which the door is arranged for right or left handed operation as required.

4. The door assembly as claimed in claim 1 in which said outer frame part is of metal construction and/or in which the outer frame part extends around the upper and opposed side edges of the main door part but not around a bottom edge of the main door part and/or in which the outer frame part has opposed side frame members bridged by an upper frame cross member and, preferably, in which said frame members are of the same or similar cross section and connected together and, preferably in which each of the frame members is of an L-shaped cross section and/or in which each of the frame members is hollow and/or in which the frame members form a receiving rebate or groove to snugly receive the main door part, in a closed position of the door, or when the main door part and outer frame are pivoted together.

5. The door assembly as claimed in claim 1 in which the first hinge axis is provided by a hinge strip having an elongate leaf with spaced plate portions being pressed or cut out of said leaf and/or in which said hinge strip is, provided with an integrally formed tubular or knuckle section, and, preferably, in which the knuckle section is recessed (at least partially) in the door jamb, in use and/or in which the knuckle section is reduced-ligature or anti-ligature in format and, preferably in which the knuckle section has a separately formed anti-ligature end cap.

6. The door assembly as claimed in claim 5 in which the second hinge axis is provided by a second hinge strip of similar format to the first mentioned hinge strip.

7. The door assembly as claimed in claim 1 in which the first and/or second hinge axis is provided by a number of aligned relatively short hinges.

8. The door assembly as claimed in claim 1 having locking means provided to lock the main door part to the outer frame part such that, when released, conventional access into the room or cell is provided for and, when locked, the main door part is secured to the outer frame part and/or in which means is provided to lock the outer frame part to a main door portal frame (lock edge door jamb) and, possibly in which electronic locking (e.g. electro-mechanical or electro-magnetic) is provided to lock/release the outer frame part from the door jamb, said electronic locking possibly being operable remotely and, preferably, in which a single operation (e.g. introduction of a key fob/electronic trigger to a sensor) is required for said electronic locking and/or having mechanical locking to lock the outer frame to the door jamb and, preferably in which two operations (e.g. upper and lower operations) are required for operation and/or in which said locking is by a turn key means and/or electro-mechanical or electro-magnetic locking systems (preferably releasable remotely) and, preferably in which the mechanical locking has a hook bolt that can pass into the outer frame part section, around a bar/retaining member therein, and back out to a lock body located in the door jamb.

9. A The door assembly as claimed in claim 1 in which the outer frame part is lockable to the main door part when required.

10. A door hinge comprising an elongate leaf adjacent an integral tubular or knuckle section of the hinge, said leaf having plate portions cut or pressed out therefrom, leaving recesses in the elongate leaf and said plate portions forming a second hinge leaf in use, the arrangement being such that, in a closed position of the hinge, the plate portions can re-enter the associated recesses in the elongate leaf and preferably in which the plate portions are similar in size and/or spaced at regular intervals.

11. The room or confined space or building having at least one door assembly as claimed in claim 1 or having at least one door hinge.

12. A door assembly comprising a door having a main part and an outer frame part, said outer frame part being pivotably mounted or mountable on a door jamb of a portal frame, in use, about a first hinge axis, and the main door part being pivotably mounted on the outer frame part about a second hinge axis spaced from the first hinge axis, the arrangement being such that, in normal use, the main door part is pivotable about the second hinge axis relative to the outer frame part to open inwardly, e.g. into a prison cell or inmate's room and, when the main door part is prevented from being opened inwardly by e.g. a barricade, access into e.g. the prison cell/room, can be gained by pivoting the main door part with the outer frame part, outwardly about the first hinge axis and in which means having a rotatable hook bolt, or electronic means, is provided to lock the outer frame part to the portal frame.
